(19) United States
(12) Patent Application Publication
(10) Pub. No.: US 2026/0280483 A1
(43) Pub. Date: Sep. 17, 2026

(54) INTERNET OF THINGS-BASED INTELLIGENT MANAGEMENT SYSTEM FOR AN INDUSTRIAL AND COMMERCIAL PHOTOVOLTAIC POWER STATION

(71) Applicant: HUANENG POWER INTERNATIONAL INC. ANHUI WIND POWER BRANCH, HEFEI (CN)

(72) Inventors: RUI XIA, HEFEI (CN); XIN WANG, HEFEI (CN); QIANG ZHANG, HEFEI (CN); LINLONG WANG, HEFEI (CN); SHUAI ZHANG, HEFEI (CN); XINYUE WANG, HEFEI (CN); TINGYU SUN, HEFEI (CN)

(73) Assignee: HUANENG POWER INTERNATIONAL INC. ANHUI WIND POWER BRANCH, HEFEI (CN)

(21) Appl. No.: 19/385,142

(22) Filed: Nov. 11, 2025

(30) Foreign Application Priority Data
Mar. 14, 2025 (CN) 202510315794.9

(51) Int. Cl. H02S 50/00

(52) U.S. Cl. CPC H02S 50/00

(57) ABSTRACT

Provided is an Internet of Things-based intelligent management system for an industrial and commercial photovoltaic power station, including: a data collection unit configured to collect real-time data of the photovoltaic power station; an edge computing node built-in with a fault prediction model and an anomaly detection model and configured to perform fault prediction and anomaly detection on the photovoltaic power station according to the collected real-time data of the photovoltaic power station, and select an optimal maintenance plan according to results of the fault prediction and the anomaly detection; and a cloud server configured to construct and train the fault prediction model based on a deep belief network, and construct the anomaly detection model based on a density-based spatial clustering algorithm. The intelligent management system effectively reduces power generation losses and high maintenance costs caused by sudden faults of the devices, and achieves maximum maintenance benefits for the power station.

### CROSS-REFERENCE TO RELATED APPLICATIONS

The present application claims priority of Chinese Patent Application No. 202510315794.9, filed on Mar. 14, 2025, the contents of which are hereby incorporated by reference.

### TECHNICAL FIELD

The present application relates to the field of power technology, and in particular, to an Internet of Things-based intelligent management system for an industrial and commercial photovoltaic power station.

### BACKGROUND

With the continuous growth of global demand for clean energy, industrial and commercial photovoltaic power stations, as an important distributed energy solution, have been widely applied and developed. Over the past few decades, photovoltaic power generation technology has continued to mature and costs have gradually decreased, enabling more and more industrial and commercial enterprises to choose to install photovoltaic power stations to reduce energy costs and achieve the goals of energy conservation and emission reduction. However, with the continuous expansion of the scale and the increasing number of photovoltaic power stations, traditional management modes are facing numerous challenges.

Traditional photovoltaic power station management modes have many limitations: data collection relies on manual inspections or simple sensor networks, with low frequency and poor accuracy; the efficiency of processing massive amounts of data is low, making it difficult to meet the needs of real-time monitoring and management; fault prediction and anomaly detection mainly rely on experience and regular maintenance, lacking scientific models, which makes it impossible to provide accurate pre-judgement and difficult to perceive subtle abnormal changes; maintenance plans are formulated based on fixed cycles and experience, which easily lead to either over-maintenance or insufficient maintenance, and the decision-making lacks comprehensive evaluation; monitoring systems are decentralized, making it difficult to conduct centralized real-time monitoring, and they lack intelligent interaction means, which affects management efficiency and the normal operation of power stations.

### SUMMARY

The present application provides an Internet of Things-based intelligent management system for an industrial and commercial photovoltaic power station to address the problems existing in the prior art, such as insufficient capabilities in fault prediction and anomaly detection, and lack of efficient monitoring and management means.

To achieve the above objective, one aspect of an embodiment of the present application provides an Internet of Things-based intelligent management system for an industrial and commercial photovoltaic power station, where the intelligent management system for an industrial and commercial photovoltaic power station includes: a data collection unit configured to collect real-time data of the photovoltaic power station; an edge computing node built-in with a fault prediction model and an anomaly detection model, the edge computing node configured to perform fault prediction and anomaly detection on the photovoltaic power station according to the collected real-time data of the photovoltaic power station, and select an optimal maintenance plan according to results of the fault prediction and the anomaly detection; and a cloud server configured to construct and train the fault prediction model based on a deep belief network, and construct the anomaly detection model based on a density-based spatial clustering algorithm.

The Internet of Things-based intelligent management system for an industrial and commercial photovoltaic power station provided by the present application: realizes real-time and high-frequency data collection through Internet of Things technology, freeing itself from traditional dependencies, and after preprocessing by the edge computing node and in-depth processing by the cloud server, efficiently and accurately analyses data; uses the fault prediction model constructed based on the deep belief network and the anomaly detection model constructed based on the density-based spatial clustering algorithm to scientifically and accurately predict faults and detect anomalies; formulates personalized maintenance planes based on detection results, and optimizes maintenance decisions through comprehensive evaluation; and realizes centralized real-time monitoring of the power station by means of an Internet of Things communication protocol, and the control terminal is equipped with a display module and an intelligent customer service system, providing a convenient and intelligent monitoring and management experience.

### BRIEF DESCRIPTION OF THE DRAWINGS

To more clearly illustrate the technical solutions in the present application or the prior art, the accompanying drawings required to be used for describing the embodiments or the prior art will be briefly introduced below. Apparently, the accompanying drawings in the following description are some embodiments of the present application, and for those of ordinary skill in the art, other accompanying drawings can also be obtained based on these accompanying drawings without making creative efforts. In the accompanying drawings:

FIG. 1 is a schematic diagram of a structure of an intelligent management system for an industrial and commercial photovoltaic power station provided by an embodiment of the present application;

FIG. 2 is a first flowchart of anomaly detection provided by an embodiment of the present application;

FIG. 3 is a second flowchart of anomaly detection provided by an embodiment of the present application;

FIG. 4 is a third flowchart of anomaly detection provided by an embodiment of the present application; and

FIG. 5 is an overall flowchart of anomaly detection provided by an embodiment of the present application.

### DETAILED DESCRIPTION OF THE EMBODIMENTS

The specific implementations of the embodiments of the present application are illustrated in detail below in combination with the accompanying drawings. It should be understood that the specific implementations described herein are used only to illustrate and explain the embodiments of the present application and are not intended to limit the embodiments of the present application.

It should be noted that the acquisition, transmission, storage, use, processing, etc. of data in the technical solutions of the present application all comply with the relevant regulations of national laws and regulations. In the embodiments of the present application, certain software, components, models, etc. existing solutions in the industry may be mentioned; they should be considered demonstrative, and their purpose is only to illustrate the feasibility of implementing the technical solutions of the present application, but does not mean that the applicant has already or necessarily used these solutions.

Amid the global wave vigorously promoting the clean energy transition, industrial and commercial photovoltaic power stations, as an important pillar in the field of distributed energy, have achieved significant development in recent years. On one hand, photovoltaic power generation technology, after years of accumulation, has continuously made breakthroughs in conversion efficiency improvement, device stability enhancement, and other aspects, with costs subsequently significantly decreasing. This has led numerous industrial and commercial enterprises to actively participate, using photovoltaic power stations to reduce electricity costs and actively respond to the call for energy saving and emission reduction. However, as the scale of photovoltaic power stations continues to expand and their numbers increasingly grow, the drawbacks of traditional management models have gradually become apparent, making it difficult to meet the demands of modern power station operation and management.

The present application is dedicated to solving the many problems in the traditional management mode of industrial and commercial photovoltaic power stations. The present application uses Internet of Things technology to collect data in real time, processes it efficiently through an edge computing node and a cloud server, utilizes a deep belief network and a density-based spatial clustering algorithm to construct a fault prediction model and an anomaly detection model respectively, scientifically formulates maintenance plans based on the detection results, conducts centralized monitoring through an Internet of Things communication protocol, and coordinates with a display module and an intelligent customer service system of an control terminal to enhance the overall operation and management level.

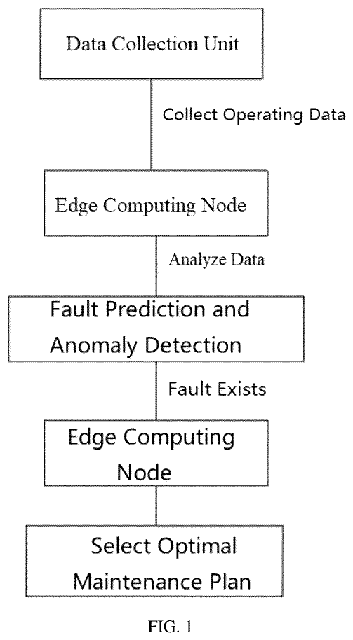

The present application is specifically described below in combination with FIG. 1 to FIG. 5.

As shown in FIG. 1, an embodiment of the present application provides an Internet of Things-based intelligent management system for an industrial and commercial photovoltaic power station, where the intelligent management system for an industrial and commercial photovoltaic power station includes: a data collection unit configured to collect real-time data of the photovoltaic power station; an edge computing node built-in with a fault prediction model and an anomaly detection model, the edge computing node configured to perform fault prediction and anomaly detection on the photovoltaic power station according to the collected real-time data of the photovoltaic power station, and select an optimal maintenance plan according to results of the fault prediction and the anomaly detection; and a cloud server configured to construct and train the fault prediction model based on a deep belief network, and construct the anomaly detection model based on a density-based spatial clustering algorithm.

The intelligent management system for an industrial and commercial photovoltaic power station provided by the present application can collect real-time operation data of each device in the photovoltaic power station through the data collection unit, then transmit the data to the edge computing node, perform fault prediction and anomaly detection on the photovoltaic power station via the fault prediction model and the anomaly detection model built in the edge computing node, and will select the optimal maintenance plan according to the results, achieving more intelligent and accurate fault prediction and anomaly detection.

The cloud server constructs the fault prediction model by using the deep belief network and trains the deep belief network repeatedly, which can accurately predict the probability that each device in the photovoltaic power station will be in a potential fault state during future operation. Meanwhile, the anomaly detection model constructed based on the density-based spatial clustering algorithm can effectively identify abnormal points in the operation data of devices in the photovoltaic power station, thereby judging whether there is an abnormal situation in the devices. The two models constructed by the cloud server provide strong intelligent analysis capabilities for the entire intelligent management system. The fault prediction model can provide early warnings of potential faults of devices, allowing operation and maintenance personnel sufficient time to take preventive measures, and reducing power generation losses and maintenance costs caused by faults; while the anomaly detection model can monitor the operating status of devices in real time, detect subtle anomalies in a timely manner, prevent the escalation of potential faults, and ensure the stable and efficient operation of the photovoltaic power station.

Preferably, the edge computing node is further configured to preprocess the data collected by the data collection unit.

In a preferred embodiment of the present application, the data collected by the data collection unit may have many problems, for example, low data frequency and poor accuracy, and the preprocessing function of the edge computing node can correct these defects in a timely manner. It can perform cleaning on the data to eliminate erroneous or invalid data caused by device failures, environmental interference, etc., so as to improve data quality. Through data aggregation, a large amount of scattered raw data is integrated according to specific rules, which reduces the amount of data transmission and alleviates network pressure.

Preferably, performing fault prediction on the photovoltaic power station includes: inputting the data collected by the data collection unit into a trained fault prediction model; calculating, by the fault prediction model via a Softmax classifier, a probability that each device in the photovoltaic power station is in a potential fault state; and when the probability that a device is in the potential fault state is greater than a preset threshold, determining that the device has a fault risk.

In a preferred embodiment of the present application, the Softmax classifier is essentially a multi-class logistic regression model, and its core function is to convert the original numerical values output by the fault prediction model into probability values of each device being in different states (normal, potential fault, etc.). In the complex operating environment of the photovoltaic power station, the device state is not a simple binary judgment of “yes” and “no”, but there are multiple gradual states. The Softmax classifier, through unique mathematical operations, namely performing exponentiation processing on the input data and normalizing it to between 0 and 1, causes the sum of the probabilities of all possible states to be 1.

For example, if the preset threshold is 0.6, for a certain inverter, the fault prediction model accurately calculates that the probability value of the inverter being in a potential fault state is 0.7. At this time, the probability of the inverter being in a potential fault state is greater than the preset threshold, so it is determined that the inverter is about to fail. The system will promptly send an early warning signal to clearly inform the operation and maintenance personnel that the device has a fault risk.

Preferably, the step of selecting an optimal maintenance plan according to results of the fault prediction and the anomaly detection includes: if it is detected that a device is faulty, calculating, for different maintenance plans, an evaluation value for impact on the photovoltaic power station; calculating a comprehensive score for each maintenance plan according to the evaluation value; and selecting a plan with a highest score as the optimal maintenance plan; where the comprehensive score is expressed as:

$${s}_{j} = {\sum }_{i = 1}^{3} {w}_{i} {v}_{ij} \qquad ( 1 )$$

where j represents different maintenance plans, vᵢⱼ represents the evaluation value, and w represents a weight.

In a preferred embodiment of the present application, if it is predicted through fault prediction and anomaly detection that a device has failed or is about to fail, one optimal maintenance plan will be selected from three plans (immediate repair, delayed repair, and device replacement). First, for different maintenance plans, their performance under factors such as device fault risk, maintenance cost, and downtime loss is evaluated respectively to obtain the corresponding evaluation values. For example, for the immediate repair plan, its possible score in reducing device fault risk may be v₁₁, its possible score in terms of maintenance cost may be v₂₁, and its possible score in reducing downtime loss may be v₃₁. Subsequently, the comprehensive score of each maintenance plan is calculated according to the evaluation values; for example, the comprehensive score of the immediate repair plan is s₁=w₁v₁₁+w₂v₂₁+w₃v₃₁. By comparing the comprehensive scores of different maintenance plans, the plan with the highest score is the optimal maintenance plan recommended by the system. For example, if the immediate repair plan has the highest comprehensive score, the system will recommend immediate repair to the operation and maintenance personnel, and provide a detailed maintenance process, suggestions for the allocation of required resources, etc., to assist the operation and maintenance personnel in carrying out device maintenance work efficiently and ensure the stable operation of the photovoltaic power station.

Preferably, the edge computing node is connected to the devices in the photovoltaic power station via an Internet of Things communication protocol and utilizes preset cameras to perform real-time monitoring of an environment of the photovoltaic power station.

In a preferred embodiment of the present application, the edge computing node achieves seamless connection with various types of devices in the photovoltaic power station via the Internet of Things communication protocol. Whether they are photovoltaic panels, inverters, or other auxiliary devices, all can conduct stable data interaction with the edge computing node through this communication protocol. The edge computing node can acquire operating parameters of the devices in real time, such as the output power of the photovoltaic panels, the operating frequency of inverters, etc., providing first-hand data support for subsequent tasks such as fault prediction and anomaly detection. At the same time, the edge computing node also integrates preset camera resources to conduct comprehensive real-time monitoring of the environment of the photovoltaic power station. The cameras capture changes in light intensity around the power station and weather conditions in real time, including whether there is cloud cover, or the occurrence of adverse weather such as rainfall or strong winds. These environmental data are crucial for evaluating the power generation efficiency of the photovoltaic power station and the operational stability of the devices. For example, insufficient light intensity may affect the power generation power of the photovoltaic panels, while extreme weather such as strong winds and heavy rains may cause physical damage to the devices. By real-time collecting and analyzing these environmental data, the edge computing node can, on the one hand, assist in judging whether the operating status of the devices is normal, and on the other hand, provide more comprehensive input information for the fault prediction model and the anomaly detection model, thereby improving the accuracy and reliability of the entire intelligent management system in judging the operating status of the photovoltaic power station and ensuring the efficient and stable operation of the power station.

Preferably, the intelligent management system further includes a control terminal configured with a display module which is configured for displaying real-time data of the photovoltaic power station, and information of the fault prediction and the anomaly detection, and the control terminal is further equipped with an intelligent customer service system based on natural language processing technology for providing answers and querying information related to the photovoltaic power station.

In a preferred embodiment of the present application, the control terminal is equipped with a display module, and the display module clearly presents the real-time data of the photovoltaic power station, including the output power of the photovoltaic panels, the operating status of the inverters, the device operating parameters, and the like. At the same time, it also shows information on fault prediction and anomaly detection in real time, enabling managers to quickly learn about the potential fault risks and abnormal operating conditions of the devices in the power station, and providing strong support for taking timely response measures. In addition, the control terminal is equipped with an intelligent customer service system based on natural language processing technology; operators only need to ask questions in natural language to easily query information related to the photovoltaic power station, such as the historical operating data and maintenance records of the devices. When encountering complex problems, the intelligent customer service system can quickly provide professional answers by virtue of its ability to understand and analyze natural language, without requiring operators to spend a lot of time searching for materials or consulting experts. This not only significantly improves the efficiency of information acquisition and reduces communication costs, but also further enhances the usability of the entire intelligent management system, enabling operators to manage the photovoltaic power station more efficiently and ensure the stable operation of the power station.

Furthermore, the application further integrates an electronic invoice system to realize the automatic settlement function, simplify the electricity fee settlement process, and improve efficiency. It provides one-stop customer service, including bill notification, electricity fee collection management, and the like, to enhance customer satisfaction.

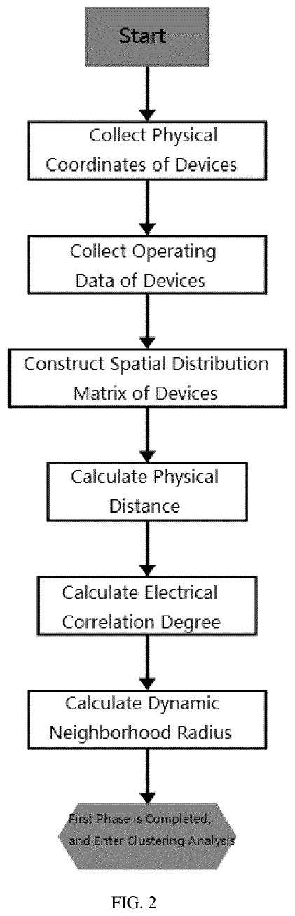

With reference to FIGS. 2-5, when performing anomaly detection on the devices in the photovoltaic power station through the anomaly detection model, it is roughly divided into three stages.

Preferably, as shown in FIG. 2, performing anomaly detection on the photovoltaic power station includes: constructing a spatial distribution matrix of devices in the photovoltaic power station according to physical coordinates of the devices and the collected data; calculating a dynamic neighborhood radius according to the constructed spatial distribution matrix and through distances and electrical correlation degrees between the devices; performing spatial clustering on each data point of the devices through the density-based spatial clustering algorithm according to the calculated dynamic neighborhood radius, to obtain a density of each data point within the dynamic neighborhood radius; determining a type of the each data point according to the obtained density of the each data point; and judging whether an anomaly exists in the devices in the photovoltaic power station and determining an anomalous device according to the determined type of the each data point. a dynamic calculation of the dynamic neighborhood radius εᵢ is expressed as:

$${ε}_{i} = ( 1 / N ) \sum {d}_{ij} \times ( 1 + {C}_{e} \cdot {E}_{ij} ) \qquad ( 2 )$$

where dᵢⱼ represents a physical distance between a device i and a device j, Eⱼⱼ represents a coefficient of electrical correlation degree, and Cₑ represents an electrical weight factor.

In the intelligent management system for an industrial and commercial photovoltaic power station, anomaly detection is an important link to ensure the stable operation of the power station. First, based on the physical coordinates of the devices in the photovoltaic power station and the collected data, the spatial distribution matrix of the devices is constructed to establish a position and data relationship diagram of all the devices in the power station, and the physical coordinates of the devices clarify the positions of the devices in the actual space. Subsequently, the dynamic neighborhood radius is calculated through Formula (2) according to the constructed spatial distribution matrix. The physical distance between devices reflects the spatial proximity of the devices, while the coefficient of electrical correlation degree reflects the tightness of the devices in terms of electrical connection and function. The dynamic neighborhood radius calculated in this way can more accurately reflect the mutual relationship of the devices in actual operation, because the physical distance and electrical correlation degree between different devices change dynamically under different operating conditions. After obtaining the dynamic neighborhood radius, the density-based spatial clustering algorithm (DBSCAN) is used to perform spatial clustering on each data point of the devices, and the type of each data point is determined. Whether there is an abnormality in the devices in the photovoltaic power station is judged according to the determined type of the each data point. Through this series of rigorous and scientific anomaly detection processes, the intelligent management system can timely and accurately detect abnormal conditions in the operation of the devices in the photovoltaic power station, provide strong support for operation and maintenance personnel to take targeted measures, ensure the continuous and stable operation of the photovoltaic power station, and improve power generation efficiency and economic benefits.

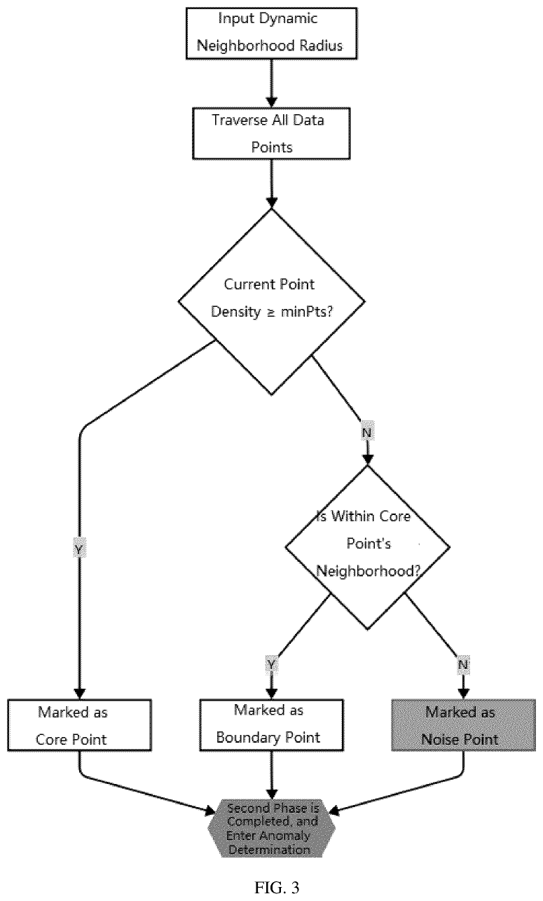

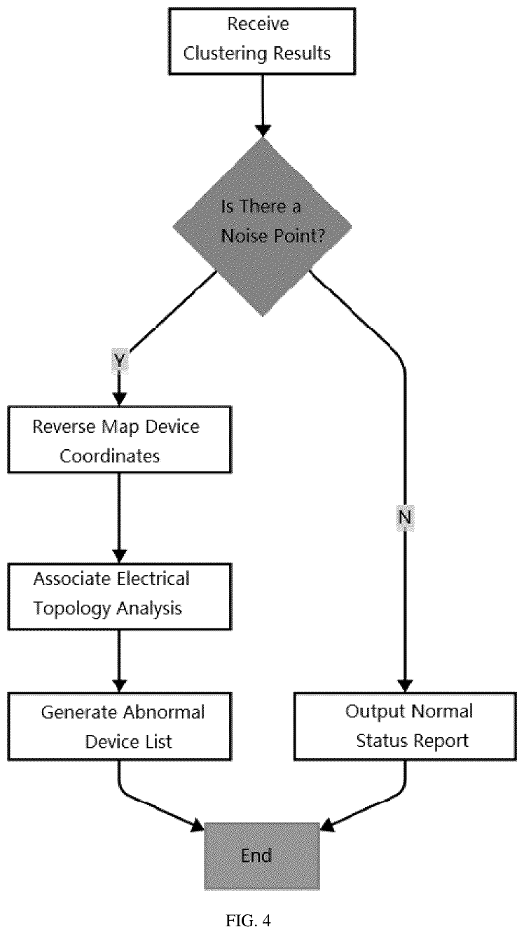

As shown in FIGS. 3 and 4, further preferably, determining a type of the each data point according to the obtained density of the each data point includes: if a density of a data point is greater than or equal to a preset minimum number of points, determining the data point as a core point; if a data point is not a core point and is located within a dynamic neighborhood radius of a core point, determining the data point as a boundary point; and if a data point is neither a core point nor a boundary point, determining the data point as a noise point. Judging whether an anomaly exists in the devices in the photovoltaic power station and determining an anomalous device according to the determined type of the each data point includes: if a noise point exists among the data points of the devices in the photovoltaic power station, determining that an anomaly exists in the devices in the photovoltaic power station, and determining the anomalous device through the spatial distribution matrix and a location of the noise point; and if no noise point exists, determining that the devices in the photovoltaic power station are operating normally.

In the above process of determining the type of data point, the number of data points within the dynamic neighborhood radius of each data point is calculated to obtain the density of each data point within the dynamic neighborhood radius. If a data point contains a sufficient number of other points in its neighborhood (i.e., the density is greater than or equal to the preset minimum number of points), the data point is determined as a core point; if a data point itself is not a core point but is within the dynamic neighborhood radius of a certain core point, it is determined as a boundary point; and if a data point is neither a core point nor a boundary point, it is determined as a noise point. Since the physical coordinates and operating parameter information of each device are recorded in detail when constructing the spatial distribution matrix of the devices, after a data point is determined as a noise point, the location of the abnormal device in the power station can be accurately located by querying the spatial distribution matrix.

For example, assuming the preset minimum number of points is 3, if there are 4 other data points within the dynamic neighborhood radius of 1.5 of Device A, the current data point of Device A is determined as a core point. If the number of data points around the data point of Device D is less than 3 (so it is not a core point) but it is within the dynamic neighborhood radius of 1.5 of Device A (a core point), the data point of Device D is determined as a boundary point at this time. If the number of data points around the data point of Device E is small and it is not within the dynamic neighborhood radius of any core point, then Device E is determined as a noise point. Since the data point of Device E is determined as a noise point, this indicates that the operating state of Device E deviates from the normal range and an abnormal condition occurs. By tracing back to the previously constructed spatial distribution matrix of the devices, Device E can be clearly identified as an abnormal device, and operation and maintenance personnel can conduct inspection and maintenance for the abnormal condition of Device E to ensure the stable operation of the photovoltaic power station.

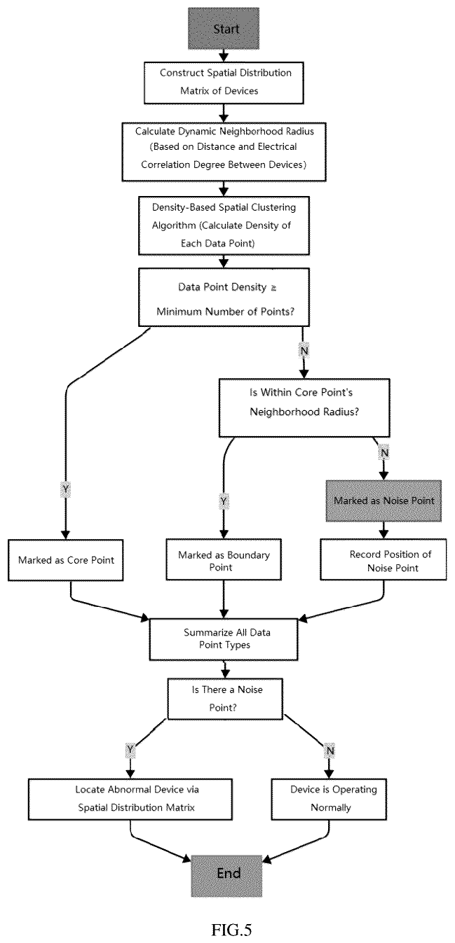

As shown in FIG. 5, the anomaly detection method provided by the present application constructs a spatial distribution matrix by integrating the physical coordinates and operating parameters of the devices in the photovoltaic power station, calculates the dynamic neighborhood radius by synthesizing the physical distance and electrical correlation degree between devices, applies the density-based spatial clustering algorithm, and accurately identifies core points, boundary points, and noise points according to the density and location of data points, thereby significantly improving detection accuracy and avoiding misjudgments and omissions; once a noise point is detected to determine an anomaly, the abnormal device can be quickly and accurately located with the help of the spatial distribution matrix, enabling operation and maintenance personnel to perform maintenance before the fault worsens, which prevents minor faults from evolving into serious ones, ensures the coordinated and stable operation of all the devices in the photovoltaic power station, improves power generation efficiency, reduces power generation losses and economic losses, and ensures the continuous supply of clean energy to industrial and commercial users.

In summary, the Internet of Things-based intelligent management system for an industrial and commercial photovoltaic power station provided by the present application:

realizes real-time, comprehensive, and high-frequency data collection through IoT technology, including various key operating data of the devices in the photovoltaic power station and addressing the shortcomings of traditional data collection; and efficiently processes data using a combined mode of edge computing and cloud computing to quickly extract key information. In terms of fault prediction and anomaly detection, the model constructed based on the deep belief network accurately predicts faults and issues early warnings several days or even weeks in advance, while the model based on the density-based spatial clustering algorithm comprehensively detects minor anomalies. When formulating maintenance plans, personalized plans are customized according to detection results to avoid over-maintenance or insufficient maintenance; and multi-dimensional evaluation of different plans is conducted to select the optimal one, so as to maximize maintenance benefits. In terms of monitoring and interactive management, it can centrally monitor the power station environment and device operation in real time. The control terminal displays key information through the display module, and cooperates with the intelligent customer service system to enhance management efficiency and user experience through natural language interaction.

It should be understood that, in various embodiments of the present application, the magnitude of the sequence numbers of the aforementioned processes does not imply the order of execution. The order of execution of each process shall be determined by its functions and inherent logic, and shall not impose any limitation on the implementation process of the embodiments of the present application.

In addition, the terms “system” and “network” herein are often used interchangeably herein. The term “and/or” herein merely describes an associative relationship between associated objects, indicating there may be three relationships. For example, “A and/or B” may mean: A exists alone, both A and B exist simultaneously, or B exists alone. In addition, the character “/” herein generally indicates an “or” relationship between the associated objects before and after it.

It should be understood that, in the embodiments of the present application, “B corresponding to A” means that B is associated with A, and B can be determined according to A. However, it should also be understood that determining B according to A does not mean that B is determined only according to A; and B may also be determined according to A and/or other information.

A person of ordinary skill in the art may recognize that the units and algorithmic steps of the examples described in conjunction with the embodiments disclosed herein can be implemented by electronic hardware, computer software, or a combination of the two. To clearly illustrate the interchangeability of hardware and software, the composition and steps of each example have been generally described above in terms of functions. Whether these functions are executed in hardware or software depends on the specific application and design constraints of the technical solution. A person of skill in the art may use different methods to implement the described functions for each specific application, but such implementation shall not be considered to go beyond the scope of the present application.

What is claimed is:

1. An Internet of Things-based intelligent management system for an industrial and commercial photovoltaic power station, wherein the intelligent management system for an industrial and commercial photovoltaic power station comprises:
a data collection unit configured to collect real-time data of the photovoltaic power station;
an edge computing node built-in with a fault prediction model and an anomaly detection model, the edge computing node configured to perform fault prediction and anomaly detection on the photovoltaic power station according to the collected real-time data of the photovoltaic power station, and select an optimal maintenance plan according to results of the fault prediction and the anomaly detection; and
a cloud server configured to construct and train the fault prediction model based on a deep belief network, and construct the anomaly detection model based on a density-based spatial clustering algorithm.

2. The intelligent management system for an industrial and commercial photovoltaic power station according to claim 1, wherein the edge computing node is further configured to preprocess the data collected by the data collection unit.

3. The intelligent management system for an industrial and commercial photovoltaic power station according to claim 1, wherein performing fault prediction on the photovoltaic power station comprises:
inputting the data collected by the data collection unit into a trained fault prediction model;
calculating, by the fault prediction model via a Softmax classifier, a probability that each device in the photovoltaic power station is in a potential fault state; and
when the probability that a device is in the potential fault state is greater than a preset threshold, determining that the device has a fault risk.

4. The intelligent management system for an industrial and commercial photovoltaic power station according to claim 1, wherein performing anomaly detection on the photovoltaic power station comprises:
constructing a spatial distribution matrix of devices in the photovoltaic power station according to physical coordinates of the devices and the collected data;
calculating a dynamic neighborhood radius according to the constructed spatial distribution matrix and through distances and electrical correlation degrees between the devices;
performing spatial clustering on each data point of the devices through the density-based spatial clustering algorithm according to the calculated dynamic neighborhood radius, to obtain a density of each data point within the dynamic neighborhood radius;
determining a type of the each data point according to the obtained density of the each data point; and
judging whether an anomaly exists in the devices in the photovoltaic power station and determining an anomalous device according to the determined type of the each data point.

5. The intelligent management system for an industrial and commercial photovoltaic power station according to claim 4, wherein a dynamic calculation of the dynamic neighborhood radius εᵢ is expressed as:
$${ε}_{i} = ( 1 / N ) \sum {d}_{ij} \times ( 1 + {C}_{e} \cdot {E}_{ij} )$$
where dᵢⱼ represents a physical distance between a device i and a device j, Eᵢⱼ represents a coefficient of electrical correlation degree, and Cₑ represents an electrical weight factor.

6. The intelligent management system for an industrial and commercial photovoltaic power station according to claim 4, wherein said determining a type of the each data point according to the obtained density of the each data point comprises:
if a density of a data point is greater than or equal to a preset minimum number of points, determining the data point as a core point;
if a data point is not a core point and is located within a dynamic neighborhood radius of a core point, determining the data point as a boundary point; and
if a data point is neither a core point nor a boundary point, determining the data point as a noise point.

7. The intelligent management system for an industrial and commercial photovoltaic power station according to claim 6, wherein said judging whether an anomaly exists in the devices in the photovoltaic power station and determining an anomalous device according to the determined type of the each data point comprises:
if a noise point exists among the data points of the devices in the photovoltaic power station, determining that an anomaly exists in the devices in the photovoltaic power station, and determining the anomalous device through the spatial distribution matrix and a location of the noise point; and
if no noise point exists, determining that the devices in the photovoltaic power station are operating normally.

8. The intelligent management system for an industrial and commercial photovoltaic power station according to claim 1, wherein said selecting an optimal maintenance plan according to results of the fault prediction and the anomaly detection comprises:
if it is detected that a device is faulty,
calculating, for different maintenance plans, an evaluation value for impact on the photovoltaic power station;
calculating a comprehensive score for each maintenance plan according to the evaluation value; and
selecting a plan with a highest score as the optimal maintenance plan;
wherein the comprehensive score S is expressed as:
$${s}_{j} = {\sum }_{i = 1}^{3} {w}_{i} {v}_{ij}$$
where j represents different maintenance plans, vᵢⱼ represents the evaluation value, and w represents a weight.

9. The intelligent management system for an industrial and commercial photovoltaic power station according to claim 1, wherein the edge computing node is connected to the devices in the photovoltaic power station via an Internet of Things communication protocol and utilizes preset cameras to perform real-time monitoring of an environment of the photovoltaic power station.

10. The intelligent management system for an industrial and commercial photovoltaic power station according to claim 1, wherein the intelligent management system further comprises a control terminal configured with a display module which is configured for displaying real-time data of the photovoltaic power station, and information of the fault prediction and the anomaly detection, and
the control terminal is further equipped with an intelligent customer service system based on natural language processing technology for providing answers and querying information related to the photovoltaic power station.
